(19) United States
(12) Patent Application Publication
(10) Pub. No.: US 2026/0212439 A1
(43) Pub. Date: Jul. 23, 2026

(54) ZERO-COPY GRAPHIC PROCESSING UNIT DIRECT STORAGE WITH ERASURE CODING

(71) Applicant: Dell Products L.P., Round Rock, TX (US)

(72) Inventors: Xiangping Chen, Sherborn, MA (US); Jonathan Ichael Krasner, Coventry, RI (US); Ramesh Doddaiah, Westborough, MA (US)

(21) Appl. No.: 19/034,199

(22) Filed: Jan. 22, 2025

(51) Int. Cl. G06T 1/20; G06T 1/60

(52) U.S. Cl. CPC G06T 1/20; G06T 1/60

(57) ABSTRACT

A method for storing files includes receiving, at a central processing unit (CPU) of a host, a write request for a first data segment located in a graphics processing unit (GPU) data buffer to remote storage servers. The method further includes making a determination that the GPU is available for erasure coding (EC) of the first data segment. In addition, the method includes allocating in the GPU, an EC buffer. Moreover, the method includes engaging an EC calculation to cause the GPU to execute the EC calculation using the EC buffer to cause the GPU to generate an EC data segment associated with the first data segment. Further, the method includes initiating a path between the GPU and the remote storage servers to cause the first data segment and the EC data segment to transfer directly from the GPU to a location remote to the host.

### BACKGROUND

For many data processes, including for artificial intelligence applications, data used in an application on a host needs to be stored in persistent storage such as a remote storage server. This data may be stored on memory on a graphic processing unit (GPU) prior to being stored in the remote storage server. GPU direct storage (GDS) may provide a direct memory access path between memory of the GPU and the remote storage server but can only be utilized if the data does not require processing outside of the GPU in the host. When GDS cannot be utilized such as with parallel file systems with direct Input/Output paths to persistent storage, erasure coding (EC) must be calculated by a file system client on the host. The data stored on the memory of the GPU is copied to the central processing unit (CPU) of the host for erasure coding before being stored in the remote storage server.

### BRIEF DESCRIPTION OF DRAWINGS

Certain embodiments disclosed herein will be described with reference to the accompanying drawings. However, the accompanying drawings illustrate only certain aspects or implementations of one or more embodiments disclosed herein by way of example and are not meant to limit the scope of the claims.

FIG. 1 shows a diagram of a system in accordance with one or more embodiments disclosed herein.

FIG. 2.1 shows a flowchart for a method for storing files in accordance one or more embodiments disclosed herein.

FIG. 2.2 shows a flowchart for a method for storing files in accordance one or more embodiments disclosed herein.

FIG. 3.1 shows a first example use case of a system for storing data in accordance with one or more embodiments disclosed herein.

FIG. 3.2 show a second example use case of a system for storing data in accordance with one or more embodiments disclosed herein.

FIG. 4 shows a diagram of a computing device in accordance with one or more embodiments disclosed herein.

### DETAILED DESCRIPTION

In traditional file systems, data may be stored on memory included within a graphic processing unit (GPU) of a host prior to being stored in the remote storage server. The host may store the data on the remote storage server using GPU direct storage (GDS) direct memory access path between memory of the GPU and the remote storage server. However, GDS cannot be utilized when the data is processed outside the GPU in the host. Therefore, processing of the data can be pushed to the remote storage server or a central processing unit (CPU) bounce buffer or data processing unit (DPU) bounce buffer (when a DPU is connected to the host) may be used in lieu of GDS. The CPU bounce buffer consists of copying the data from the GPU to the CPU to do an erasure coding (EC) to be able to store the data in the remote storage server. DPU bounce buffer is similar with the data being copied in the DPU for the EC. The extra GPU to CPU memory copy consumes CPU resources and memory bandwidth, significantly hampers write performance, especially during checkpointing of AI applications, and prevents the GPU from performing other operations during the pendency of the transfer of data from the GPU to the CPU. When a DPU is used in the host for a trusted storage environment, the DPU bounce exacerbates these problems due to a limited memory bandwidth comparing the DPU to a regular server host CPU. For at least the reasons discussed above, a different approach for enable GDS in file systems may be beneficial.

Embodiments disclosed herein relate to enabling GDS by using EC calculated on the GPU. If the EC is calculated using computing power of the GPU and the EC buffer created by the calculation is stored in memory of the GPU, the data can stay in the GPU and a GDS remote direct memory access (RDMA) engine can directly transfer the data and EC buffers from the GPU to the remote storage server. In this case, the host determines whether data to be transferred is in a memory domain of the GPU and then engages the GPU to compute the EC. Finally, the host establishes a GDS path from the memory domain of the GPU to the remote storage server for data to be transferred. The embodiments are especially beneficial for artificial intelligence (AI) training checkpointing, as the GPU is not used for AI training and therefore has computing power available that can be used for EC calculation during the AI checkpointing until the data is persisted on the storage system. Other benefits of the disclosure include utilizing available computational power and memory of the GPU for the EC calculations and bypassing the need for a CPU bounce buffer (thus, avoiding the disadvantages of CPU bounce buffer). The embodiments support GDS zero-copy transfers, including when EC must be completed before the RDMA path to remote storage system (when traditional methods of GDS would fail). The embodiments allow use of computer resources of the GPU during times when the GPU would be idle (e.g., AI checkpointing).

The following describes various embodiments disclosed herein.

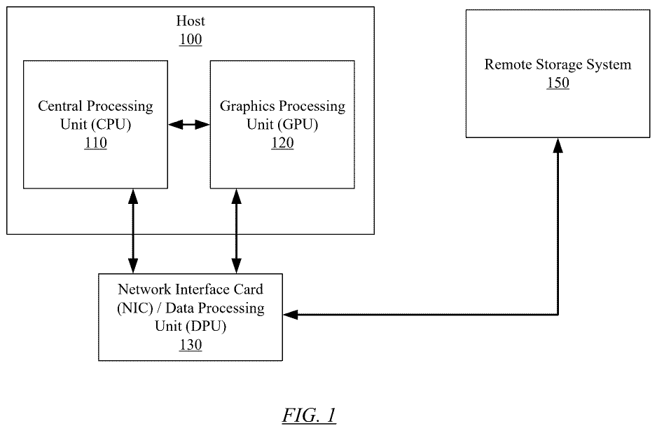

FIG. 1 shows a diagram of a system in accordance with one or more embodiments disclosed herein. The system includes a host (100), a network interface card (NIC)/Data Processing Unit (DPU) (130), and a remote storage system (150). Each of these components shown in FIG. 1 is described below.

The system may include additional, fewer, and/or different components without departing from the scope of the embodiments disclosed herein. Each component may be operably/operatively connected to any of the other components via any combination of wired and/or wireless connections (including connections to local area networks, wireless networks, and wide area networks). For example, the components shown in FIG. 1 may be connected via a network fabric (not shown). A network fabric refers to the interconnected topology and structure of network elements, e.g., switches, routers, and links, which work together to provide data transmission within between the components. The network fabric may be implemented using a spine-leaf topology, where every leaf switch connects to each spine switch. Those skilled in the art will appreciate that any other type of network (or network topology) may be used without departing from the disclosure.

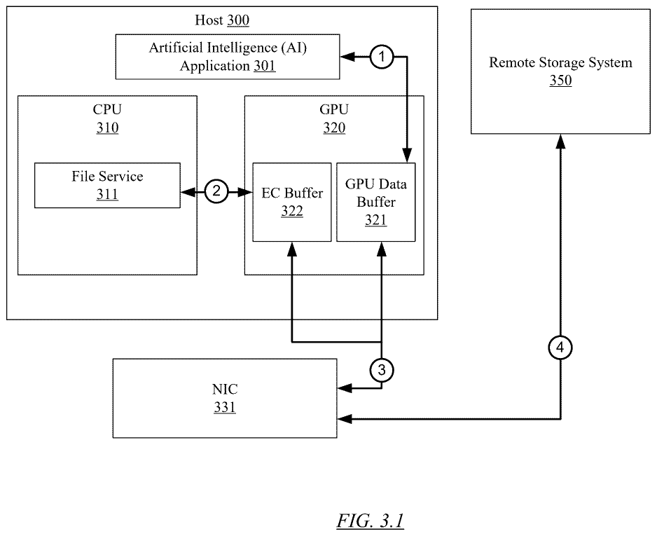

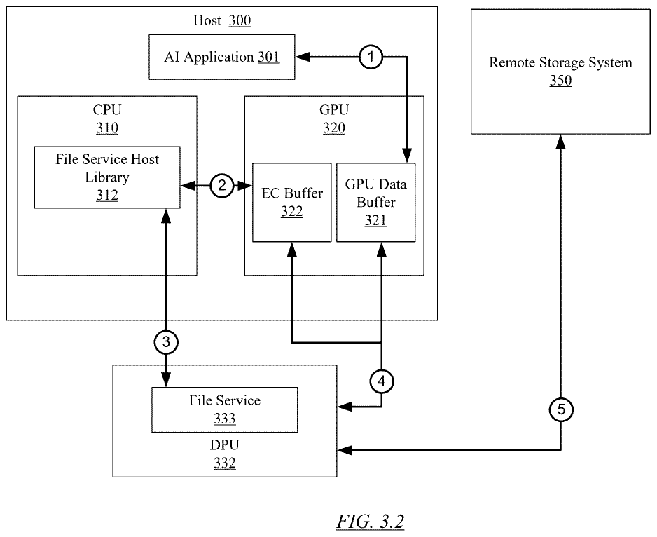

The host (100) is configured to be used to save data on the remote storage system (150). In one or more embodiments, the host (100) receives or create the data. In one or more embodiments, the host (100) are operatively connected to other devices and the data is transmitted to the host (100) from the other devices. For example, the hosts (100) may include infrastructure nodes that have more available resources than other devices and thus may be able to complete more resource-intensive tasks or perform tasks more quickly than the other devices may be capable of. In one or more embodiments, the host (100) includes the functionality to initiate storage of checkpoint data (e.g., the model's state during training-model weights, optimizer states), data used for AI model training (e.g., training data) and AI inferencing (e.g., applying AI models to data sets) in the remote storage system (150). The host has the functionality to execute AI applications as shown in FIG. 3.1-3.2.

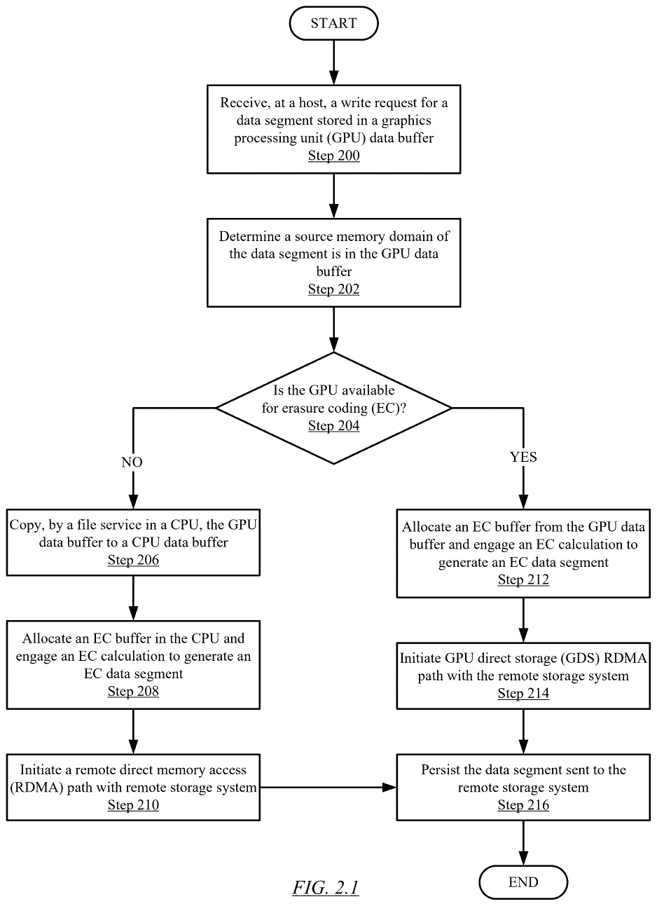

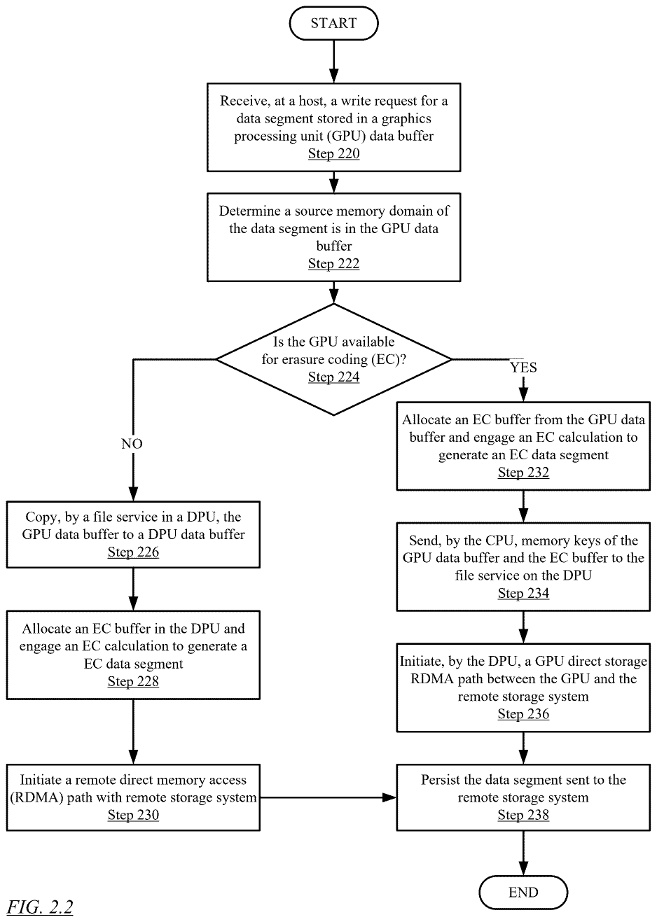

In one or more embodiments, the host (100) includes a CPU (110) and a GPU (120). The CPU (110) is an electronic component containing electronic circuitry to execute instructions of a computer program. The CPU (110) is the main processor of the host (100). The CPU (110) includes functionality to perform some of the methods shown in FIG. 2.1-2.2. The CPU includes the file service client (not shown) which can execute tasks as shown in FIG. 2.1-2.2. The file service client includes a file service and a file service library. In one or more embodiments, the file service library and file service are included together in the CPU (110). In one or more embodiments, the file service library is included in the CPU (110) and the file service is executing on another component of the host (100). The CPU (110) can implement additional functionality without departing from the disclosure.

In one or more embodiments, the GPU (120) is a specialized electronic component that includes multiple cores (also referred to as GPU cores) arranged to enable high-performance parallel computing tasks. The GPU (120) may also include large amounts of volatile memory to support the parallel processing of the multiple GPU cores. The GPU (120) also includes functionality to perform all or some of the methods shown in FIG. 2.1-2.2. The GPU (120) may include a GPU kernel. A GPU kernel is a routine that allows the GPU to perform computations without using the CPU (110). The GPU (120) can implement additional functionality without departing from the disclosure.

Though not shown in FIG. 1, the host (100) may include other hardware components such as processors, volatile storage (e.g., memory), non-volatile storage (e.g., disk drives, solid state drives, etc.), and other computing components.

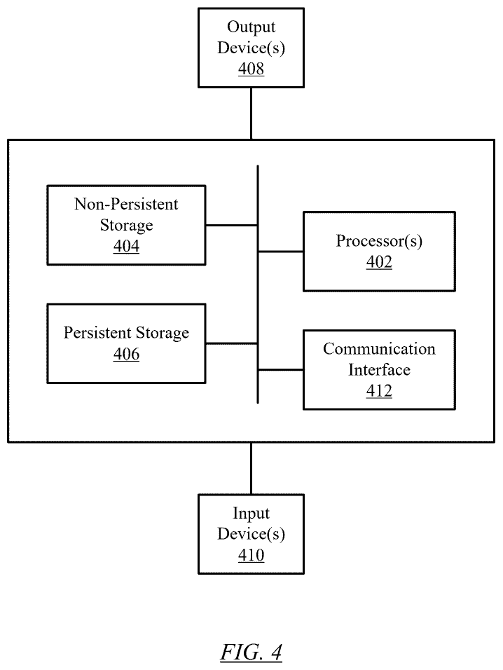

In one or more embodiments, the hosts (100) are implemented as one or more computing devices (see e.g., FIG. 4). The computing device(s) may be, for example, a server, a distributed computing system, or a cloud resource. The computing device may include one or more processors, memory (e.g., random access memory), and persistent storage (e.g., disk drives, solid state drives, etc.). The computing device may provide the functionality of the hosts (100) described throughout this application and/or all, or a portion thereof, of the methods illustrated in FIG. 2.1-2.2.

In one or more embodiments, the hosts (100) are implemented as a logical device(s) (e.g., a virtual machine). Each logical device may utilize the computing resources of any number of computing devices and thereby provide the functionality of the hosts (100) described throughout this application and/or all, or a portion thereof, of the methods illustrated in FIG. 2.1-2.2.

In one or more embodiments, the NIC/DPU (130) has functionality to transmit data over a network to the remote storage system (150). The NIC/DPU (130) may be a NIC, a DPU, or contain both. The NIC is a hardware component that connects the host to the network. The NIC can implement additional functionality without departing from the disclosure. In one or more embodiments, the DPU connects the host to the network and no NIC is present.

In one or more embodiments, the DPU is a specialized electronic component that includes one or more network interfaces and is designed to offload various networking tasks (e.g., packet processing, encryption, data compression, and network virtualization) that would normally be handled by the CPU (110) or the GPU (120). In one or more embodiments, the file service of the file service client is executed on the DPU. In addition, the DPU can perform can handle the tasks of the NIC and can act essentiality as a smart NIC. The DPU also includes functionality to perform all or some of the methods shown in FIG. 2.1-2.2. The DPU can implement additional functionality without departing from the disclosure.

In one or more embodiments, the remote storage system (150) includes the functionality to store checkpoint data, data used for AI model training, and AI inferencing in the remote storage system (150). In one or more embodiments, the remote storage system (150) may be implemented as a file store. When implemented as a file store, the remote storage system (150) stores data as files and manages the files using the file system. The file system may organize the files within a hierarchy using, for example, directories and/or folders. In one or more embodiments, the remote storage system (150) may be implemented as an object store. When implemented as an object store, the data is stored as discrete units called objects (instead of files). Each object includes the data itself, metadata that describes the data, and a unique identifier, allowing for efficient retrieval and organization.

In one or more embodiments, the remote storage system (150) may be implemented as one or more computing devices (see e.g., FIG. 4). The computing device(s) may be, for example, a server, a distributed computing system, or a cloud resource. The computing device may include one or more processors, memory (e.g., random access memory), and persistent storage (e.g., disk drives, solid state drives, etc.). The computing device may provide the functionality of the remote storage system (150) described throughout this application and/or all, or a portion thereof, of the methods illustrated in FIG. 2.1-2.2. The remote storage system may utilize, to store data, volatile storage, non-volatile storage, or any combination thereof to store the aforementioned data. Examples of storage include (but are not limited to): a hard disk drive (HDD), a solid-state drive (SSD), random access memory (RAM), flash memory, a tape drive, a fibre-channel (FC) based storage device, a floppy disk, a diskette, a compact disc (CD), a digital versatile disc (DVD), a non-volatile memory express (NVMe) device, a NVMe over Fabrics (NVMe-oF) device, resistive RAM (ReRAM), and persistent memory (PMEM).

In one or more embodiments, the remote storage system (150) is implemented as a logical device(s). Each logical device may utilize the computing resources of any number of computing devices and thereby provide the functionality of the remote storage system (150) described throughout this application and/or all, or a portion thereof, of the methods illustrated in FIG. 2.1-2.2.

Turning now to FIG. 2.1, FIG. 2.1 shows a flowchart for a method for storing data in accordance one or more embodiments disclosed herein. The method of FIG. 2.1 may be performed by, for example, the host (e.g., 100, FIG. 1) and related sub-components such as the CPU (e.g., 110, FIG. 1) and the GPU (e.g., 120, FIG. 1). Other components of the system of FIG. 1 may perform all, or a portion, of the method of FIG. 2.1 without departing from the disclosure.

While the various steps in the flowchart of FIG. 2.1 are presented and described sequentially, one of ordinary skill in the relevant art will appreciate that some or all of the steps may be executed in different orders, may be combined, or omitted, and some or all steps may be executed in parallel.

In Step 200, the host receives a write request for a data segment stored in a GPU data buffer in the GPU. A parallel file system client executing on the CPU receives the write request. The write request includes that the data segment should be written to the remote storage servers (e.g., remote storage system (150), FIG. 1). The data segment is contained in the GPU in the GPU data buffer.

In Step 202, the host makes a first determination that a source memory domain of the data segment is in the GPU data buffer. The first determination that the source memory domain of the data segment is in the GPU data buffer ensures the method may proceed as the method depends on transferring data from the GPU to a remote storage. As such, source memory domain must reside in the memory domain of the GPU for GDS to be possible. If the source memory domain is in the CPU the method cannot continue and an alternative storage method will be used.

In Step 204, the host makes a second determination as to whether the GPU is available for EC. The file service client of the CPU makes the second determination as to whether the GPU has available and sufficient computing and memory resources to perform EC calculations. If the GPU has the computing and memory resources to perform the EC calculations the answer to the second determination is YES. If the GPU does not have the necessary computing and memory resources the answer is NO. Accordingly, in one or more embodiments, if the result of the second determination is NO, the method proceeds to Step 206. If the result of the second determination is YES, the method alternatively proceeds to Step 212.

In one or more embodiments, EC is a data protection method that provides redundancy protection of data without having to generate multiple, full copies of the data. To do so, EC generally includes splitting data into chunks, expanding the chunks, and encoding the chunks with redundant data. These chunks can then be sent to storages across various locations such that if even multiple of the chunks are lost, the original data can still be reconstructed. However, as can be seen, EC requires additional computational resources and memory to complete. Further, embodiments of the disclosure are agnostic as to which particular type of EC is implemented.

In Step 206, the file service client in the CPU copies the GPU data buffer to a CPU data buffer. The GPU data buffer containing the data segment is copied to the CPU in order to perform the EC calculations on the CPU which could not be performed on the GPU because of a lack of computing and memory resources. The act of copying the GPU data buffer to the CPU is part of a CPU bounce buffer.

In Step 208, the CPU allocates an EC buffer in the CPU. The CPU engages an EC calculation to generate an EC data segment. The file service client of the CPU allocates the EC buffer in a memory domain of the CPU. The file service client also performs the EC calculation. The EC calculation is also a part of the CPU bounce buffer.

In Step 210, the CPU initiates a RDMA path with the remote storage system. The file service client transmits the EC data buffer and the CPU data buffer containing the data segment to the remote storage servers via a NIC (e.g., 130, FIG. 130) on the RDMA path. After Step 210, the method proceeds to Step 216.

In Step 212, the file service client allocates an EC buffer from the GPU data buffer. The file service client checks the availability of the GPU prior to the EC buffer being allocated and issues an EC compute request to the GPU. The GPU engages an EC calculation to generate an EC data segment. The EC calculation is performed using a GPU kernel (i.e., processing capability of the GPU separate from the CPU). The GPU executes the EC calculation using the EC buffer and the GPU kernel and generates the EC data segment associated with the data segment. The GPU generates RDMA memory keys for the EC buffer and attaches the RDMA memory keys to the write request. The write request with the RDMA memory keys are forwarded to a lower level of the file service client of the CPU. The GPU data buffer and the data segment are not copied to the CPU, so the CPU bounce buffer is eliminated, and the transfer is considered a zero-copy.

In Step 214, the host initiates GDS RDMA path with the remote storage system. The file service client sets up the GDS RDMA path between the GPU and the remote storage servers using the RDMA memory keys. The data segment and the EC data segment to transfer directly from the GPU to the remote storage servers. The GDS RDMA path goes through the NIC.

In Step 216, the remote storage system persists the data segment sent to the remote storage system. The EC data segment is also persisted. The data is stored on the remote storage servers and can be read by the host or other hosts for applications to use.

In one or more embodiments, the method ends after Step 216.

FIG. 2.2 shows a flowchart for a method for storing data in accordance one or more embodiments disclosed herein. FIG. 2.2 shows a flowchart for a method for storing data in accordance one or more embodiments disclosed herein. The method of FIG. 2.2 may be performed by, for example, the DPU (e.g., 130, FIG. 1), the host (e.g., 100, FIG. 1) and related sub-components such as the CPU (e.g., 110, FIG. 1) and the GPU (e.g., 120, FIG. 1). Other components of the system of FIG. 1 may perform all, or a portion, of the method of FIG. 2.2 without departing from the disclosure.

While the various steps in the flowchart of FIG. 2.2 are presented and described sequentially, one of ordinary skill in the relevant art will appreciate that some or all of the steps may be executed in different orders, may be combined, or omitted, and some or all steps may be executed in parallel.

In Step 220, the host receives a write request for a data segment stored in a GPU data buffer in the GPU. A parallel file system client (i.e., file service) executing on the DPU receives the write request. In one or more embodiments, the file service of the DPU is connected to a file service host library of the CPU. The write request includes that the data segment should be written to the remote storage servers (e.g., remote storage system (150), FIG. 1). The data segment is contained in the GPU in the GPU data buffer.

In Step 222, the host makes a first determination that a source memory domain of the data segment is in the GPU data buffer. The first determination that the source memory domain of the data segment is in the GPU data buffer ensures the method may proceed. The source memory domain must reside in the memory domain of the GPU for GDS to be possible. If the source memory domain is in the CPU or DPU the method cannot continue, and an alternative storage method will be used.

In Step 224, the host makes a second determination as to whether the GPU is available for EC. The file service of the DPU makes the second determination as to whether the GPU has available and sufficient computing and memory resources to perform EC calculations. If the GPU has the computing and memory resources to perform the EC calculations the answer to the second determination is YES. If the GPU does not have the necessary computing and memory resources the answer is NO. Accordingly, in one or more embodiments, if the result of the second determination is NO, the method proceeds to Step 226. If the result of the second determination is YES, the method alternatively proceeds to Step 232.

In Step 226, the file service in the DPU copies the GPU data buffer to a DPU data buffer. The GPU data buffer containing the data segment is copied to the DPU in order to perform the EC calculations on the DPU which could not be performed on the GPU because of a lack of computing and memory resources. The act of copying the GPU data buffer to the DPU is part of a DPU bounce buffer.

In Step 228, the DPU allocates an EC buffer in the DPU. The DPU engages an EC calculation to generate an EC data segment. The file service of the DPU allocates the EC buffer in a memory domain of the DPU. The file service also performs the EC calculation. The EC calculation is also a part of the DPU bounce buffer.

In Step 230, the DPU initiates a RDMA path with the remote storage system. The file service transmits the EC data buffer and the DPU data buffer containing the data segment to the remote storage servers via NIC (e.g., 130, FIG. 1). In one or more embodiments, the NIC is replaced by the DPU and the DPU transmits the data segment to the remote storage servers. After Step 230, the method proceeds to Step 236.

In Step 232, a file service library of the CPU allocates an EC buffer from the GPU data buffer. The file service library checks the availability of the GPU prior to the EC buffer being allocated and issues an EC compute request to the GPU. The GPU engages an EC calculation to generate an EC data segment. The EC calculation is performed using a GPU kernel (i.e., processing capability of the GPU separate from the CPU). The GPU executes the EC calculation using the EC buffer and the GPU kernel and generates the EC data segment associated with the data segment. The GPU generates RDMA memory keys for the EC buffer and attaches the RDMA memory keys to the write request. The write request with the RDMA memory keys are forwarded to a lower level of the file service library of the CPU. The GPU data buffer and the data segment are not copied to the CPU or the DPU, so the DPU bounce buffer is eliminated and the transfer is zero-copy.

In Step 234, the CPU sends the memory keys for the GPU data buffer and the EC buffer to the DPU. The memory keys (RDMA memory keys) are transmitted from the file service library to the file service on the DPU. The DPU uses the memory keys to initiate a path to the remote storage system.

In Step 236, the DPU initiates a GDS RDMA path between the GPU and the remote storage system. The file service sets up the GDS RDMA path between the GPU and the remote storage servers using the RDMA memory keys. The data segment and the EC data segment to transfer directly from the GPU to the remote storage servers. The GDS RDMA path goes through the NIC. In one or more embodiments, the functionality of the NIC is replaced by the DPU.

In Step 238, the remote storage system persists the data segment sent to the remote storage system. The EC data segment is also persisted. The data is stored on the remote storage servers and can be read by the host or other hosts for applications to use.

In one or more embodiments, the method ends after Step 238.

### Start of First Example

The following section describes an example. The example, illustrated in FIG. 3.1, is not intended to limit the disclosure and is independent from any other examples discussed in this application. This example includes only the components necessary to describe the example and other components may be used with the example. Turning to the example, consider a scenario of storing data from an AI application (301) from on a host (300) to a remote storage system (350). The data is an AI checkpoint for an AI model undergoing training in the AI application (301). The AI checkpoint is a snapshot of the AI model at the time the checkpoint is created and can be used to save progress if the AI model suffers a failure later in the training process. The AI application (301) is being executed by the host (300). The host (300) includes a CPU (310) and a GPU (320). A NIC (331) is connected to the host (300) and is the host's connection to the network including the remote storage system (350).

First, the AI application (301) reaches a point in training the AI model when an AI checkpoint is appropriate. The AI application (301) transmits a write request for a data segment stored on the GPU (320) as a part of the checkpoint process [1]. The file service (311) running on the CPU (310) makes a first determination that a source memory domain of the data segment is in a GPU data buffer (321) of the GPU (320). The file service (311) then makes a second determination that the GPU (320) has available computing and memory resources to perform EC calculations.

After the second determination is made, the file service library (contained in the file service (311)) of the CPU allocates an EC buffer (322) in the GPU to perform EC calculations on the data segment. The GPU (320) then engages an EC calculation to generate an EC data segment which is stored in the EC buffer (322). The GPU (320) then calculates memory keys for the EC buffer (322) and attaches the memory keys to the write request. The write request with the memory keys is transmitted to the file service (311) [2].

The file service (311) initiates a GDS RDMA path between the GPU (320) and the remote storage system (350) via the NIC (331) [3]. The file service (311) uses the memory keys to form the GDS RDMA path. Both the data segment and the EC data segment are transferred via the GDS RDMA path.

The data segment and the EC data segment are transferred to the remote storage system (350) via the GDS RDMA path. The data segment and the EC data segment are persisted on the remote storage system (350) [4]. The data segment can be read as needed from the remote storage system and the AI checkpoint for the data segment is completed.

### End of First Example

### Start of Second Example

The following section describes an example. The example, illustrated in FIG. 3.2, is not intended to limit the disclosure and is independent from any other examples discussed in this application. This example includes only the components necessary to describe the example and other components may be used with the example. Turning to the example, consider a scenario of storing data from an AI application (301) from a host (300) to a remote storage system (350). The data is an AI checkpoint for an AI model undergoing training in the AI application (301). The AI checkpoint is a snapshot of the AI model at the time the checkpoint is created and can be used to save progress if the AI model suffers a failure later in the training process. The AI application (301) is being executed by the host (300). The host (300) includes a CPU (310) and a GPU (320). A DPU (332) is connected to the host (300) and is the host's connection (e.g., acts as a NIC) to the network including the remote storage system (350).

First, the AI application (301) reaches a point in training the AI model when an AI checkpoint is appropriate. The AI application (301) transmits a write request for a data segment stored on the GPU (320) as a part of the checkpoint process [1]. The file service library (312) running on the CPU (310) makes a first determination that a source memory domain of the data segment is in a GPU data buffer (321) of the GPU (320). The file service library (312) then makes a second determination that the GPU (320) has available computing and memory resources to perform EC calculations.

After the second determination is made, the file service library (312) of the CPU allocates an EC buffer (322) in the GPU (320) to perform EC calculations on the data segment. The GPU then engages an EC calculation to generate an EC data segment which is stored in the EC buffer (322). The GPU then calculates memory keys for the EC buffer (322) and attaches the memory keys to the write request. The write request with the memory keys is transmitted to the file service library (312) [2]. The file service library (312) then transmits the memory keys to a file service (333) on the DPU (332) [3].

The file service (333) initiates a GDS RDMA path between the GPU (320) and the remote storage system (350) via the DPU (332) [4]. The file service (333) uses the memory keys to form the GDS RDMA path. Both the data segment and the EC data segment are transferred via the GDS RDMA path.

The data segment and the EC data segment are transferred to the remote storage system (350) via the GDS RDMA path. The data segment and the EC data segment are persisted on the remote storage system [5]. The data segment can be read as needed from the remote storage system and the AI checkpoint for the data segment is completed.

### End of Second Example

As discussed above, embodiments of the disclosure may be implemented using computing devices. FIG. 4 shows a diagram of a computing device in accordance with one or more embodiments disclosed herein. The computing device may include one or more computer processor(s) (402), non-persistent storage (404) (e.g., volatile memory, such as RAM, cache memory), persistent storage (406) (e.g., a hard disk, an optical drive such as a compact disk (CD) drive or digital versatile disk (DVD) drive, a flash memory, etc.), a communication interface (412) (e.g., Bluetooth interface, infrared interface, network interface, optical interface, etc.), input devices (410), output devices (408), and numerous other elements (not shown) and functionalities. Each of these components is described below.

In one embodiment of the disclosure, the processor(s) (402) may be an integrated circuit for processing instructions. For example, the computer processor(s) may be one or more cores or micro-cores of a processor. The computing device may also include one or more input devices (410), such as a touchscreen, keyboard, mouse, microphone, touchpad, electronic pen, or any other type of input device. Further, the communication interface (412) may include an integrated circuit for connecting the computing device to a network (not shown) (e.g., a local area network (LAN), a wide area network (WAN) such as the Internet, mobile network, or any other type of network) and/or to another device, such as another computing device.

In one embodiment of the disclosure, the computing device may include one or more output devices (408), such as a screen (e.g., a liquid crystal display (LCD), a plasma display, touchscreen, cathode ray tube (CRT) monitor, projector, or other display device), a printer, external storage, or any other output device. One or more of the output devices may be the same or different from the input device(s). The input and output device(s) may be locally or remotely connected to the computer processor(s) (402), non-persistent storage (404), and persistent storage (406). Many different types of computing devices exist, and the aforementioned input and output device(s) may take other forms.

Software instructions in the form of computer readable program code to perform embodiments described herein may be stored, in whole or in part, temporarily or permanently, on a non-transitory computer readable medium such as a CD, DVD, storage device, a diskette, a tape, flash memory, physical memory, or any other physical computer readable storage medium. Specifically, the software instructions may correspond to computer readable program code that, when executed by a processor(s), is configured to enable the computer processor to perform one or more embodiments described herein.

The problems discussed above should be understood as being examples of problems solved by embodiments of the disclosure disclosed herein and the disclosure should not be limited only to solving the same/similar problems. The disclosure is broadly applicable to address a range of problems beyond those discussed herein.

Specific embodiments are described with reference to the accompanying figures. In the above description, numerous details are set forth as examples. It will be understood by those skilled in the art, that one or more embodiments of the present disclosure may be practiced without these specific details, and that numerous variations or modifications may be possible without departing from the scope. Certain details known to those of ordinary skill in the art are omitted to avoid obscuring the description.

In the prior description of the figures, any component described with regard to a figure, in various embodiments of the disclosure, may be equivalent to one or more like-named components described with regard to any other figure. For brevity, descriptions of these components are not repeated with regard to each figure. Thus, each and every embodiment of the components of each figure is incorporated by reference and assumed to be optionally present within every other figure having one or more like-named components. Additionally, in accordance with various embodiments of the disclosure, any description of the components of a figure is to be interpreted as an optional embodiment, which may be implemented in addition to, in conjunction with, or in place of the embodiments described with regard to a corresponding like-named component in any other figure.

Throughout this application, elements of figures may be labeled as A to N. As used herein, the aforementioned labeling means that the element may include any number of items and does not require that the element include the same number of elements as any other item labeled as A to N unless otherwise specified. For example, a data structure may include a first element labeled as A and a second element labeled as N. This labeling convention means that the data structure may include any number of the elements. A second data structure, also labeled as A to N, may also include any number of elements. The number of elements of the first data structure and the number of elements of the second data structure may be the same or different.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

As used herein, the phrase operatively connected, or operative connection, means that there exists between elements/components/devices a direct or indirect connection that allows the elements to interact with one another in some way. For example, the phrase ‘operatively connected’ may refer to any direct (e.g., wired directly between two devices or components) or indirect (e.g., wired and/or wireless connections between any number of devices or components connecting the operatively connected devices) connection. Thus, any path through which information may travel may be considered an operative connection.

Software instructions in the form of computer readable program code to perform embodiments described herein may be stored, in whole or in part, temporarily or permanently, on a non-transitory computer readable medium such as a CD, DVD, storage device, a diskette, a tape, flash memory, physical memory, or any other physical computer readable storage medium. Specifically, the software instructions may correspond to computer readable program code that, when executed by a processor(s), is configured to perform one or more embodiments described herein.

While the disclosure has been described above with respect to a limited number of embodiments, those skilled in the art, having the benefit of this disclosure, will appreciate that other embodiments can be devised which do not depart from the scope as disclosed herein. Accordingly, the scope of the disclosure should be limited only by the attached claims.

What is claimed is:

1. A method for storing files, comprising:
receiving, at a file service client operating on a central processing unit (CPU) of a host, a write request for a first data segment located in a graphics processing unit (GPU) data buffer to remote storage servers, wherein the GPU data buffer is associated with a GPU of the host;
making a first determination that a source memory domain of the first data segment is in the GPU data buffer;
making a second determination, in response to the first determination, that the GPU is available for erasure coding (EC) of the first data segment, wherein the second determination is based on the GPU having sufficient computing and memory resources available for the EC;
allocating, in response to the second determination, in the GPU, an EC buffer;
engaging, after allocating the EC buffer, an EC calculation to cause the GPU to execute the EC calculation using the EC buffer to cause the GPU to generate an EC data segment associated with the first data segment;
generating, after performing the EC calculation, RDMA memory keys for the EC buffer;
attaching the RDMA memory keys to the write request; and
initiating, after attaching the RDMA memory keys, a path between the GPU and the remote storage servers to cause the first data segment and the EC data segment to transfer directly from the GPU to a location remote to the host, wherein the path is a GPU direct storage (GDS) remote direct memory access (RDMA) path and initiating the path is based on the RDMA memory keys.

2. The method of claim 1, wherein the first data segment is used for training an artificial intelligence model.

3. A method for storing files, comprising:
receiving, at a file service client operating on a central processing unit (CPU) of a host, a write request for a first data segment located in a graphics processing unit (GPU) data buffer to remote storage servers, wherein the GPU data buffer is associated with a GPU of the host;
making a first determination that a source memory domain of the first data segment is in the GPU data buffer;
making a second determination, in response to the first determination, that the GPU is available for erasure coding (EC) of the first data segment;
allocating, in response to the second determination, in the GPU, an EC buffer;
engaging, after allocating the EC buffer, an EC calculation to cause the GPU to execute the EC calculation using the EC buffer to cause the GPU to generate an EC data segment associated with the first data segment; and
initiating, after performing the EC calculation, a path between the GPU and the remote storage servers to cause the first data segment and the EC data segment to transfer directly from the GPU to a location remote to the host.

4. The method of claim 3, wherein the write request is in response to initiating a checkpointing an application on the host.

5. The method of claim 3, wherein the path is a GPU direct storage (GDS) remote direct memory access (RDMA) path.

6. The method of claim 5, further comprising:
prior to initiating the GDS RDMA path:
generating RDMA memory keys for the EC buffer; and
attaching the RDMA memory keys to the write request, and wherein the initiating the path is based on the RDMA memory keys.

7. The method of claim 6, further comprising:
prior to initiating the path:
sending the write request with the RDMA memory keys to a second file service client of a network interface card (NIC), and wherein the second file service client performs the initiating of the GDS RDMA path.

8. The method of claim 7, wherein the second file service client is operating on a data processing unit (DPU) of the NIC.

9. The method of claim 6, wherein the file service client performs the initiating of the GDS RDMA path.

10. The method of claim 3, wherein the first data segment is used for training an artificial intelligence model.

11. The method of claim 3, wherein the second determination is based on the GPU having sufficient computing and memory resources available for the EC.

12. A non-transitory computer readable medium (CRM) comprising computer readable program code, which when executed by a computer processor enables the computer processor to perform a method for storing files, the method comprising:
receiving, at a file service client operating on a central processing unit (CPU) of a host, a write request for a first data segment located in a graphics processing unit (GPU) data buffer to remote storage servers, wherein the GPU data buffer is associated with a GPU of the host;
make a first determination that a source memory domain of the first data segment is in the GPU data buffer;
making a second determination, in response to the first determination, that the GPU is available for erasure coding (EC) of the first data segment;
allocating, in response to the second determination, in the GPU, an EC buffer;
engaging, after allocating the EC buffer, an EC calculation to cause the GPU to execute the EC calculation using the EC buffer to cause the GPU to generate an EC data segment associated with the first data segment; and
initiating, after performing the EC calculation, a path between the GPU and the remote storage servers to cause the first data segment and the EC data segment to transfer directly from the GPU to a location remote to the host.

13. The non-transitory CRM of claim 12, wherein the write request is in response to initiating a checkpointing an application on the host.

14. The non-transitory CRM of claim 12, wherein the path is a GPU direct storage (GDS) remote direct memory access (RDMA) path.

15. The non-transitory CRM of claim 14, further comprising:
prior to initiating the GDS RDMA path:
generating RDMA memory keys for the EC buffer; and
attaching the RDMA memory keys to the write request, and wherein the initiating the path is based on the RDMA memory keys.

16. The non-transitory CRM of claim 15, further comprising:
prior to initiating the path:
sending the write request with the RDMA memory keys to a second file service client of a network interface card (NIC), and wherein the second file service client performs the initiating of the GDS RDMA path.

17. The non-transitory CRM of claim 16, wherein the second file service client is operating on a data processing unit (DPU) of the NIC.

18. The non-transitory CRM of claim 15, wherein the file service client performs the initiating of the GDS RDMA path.

19. The non-transitory CRM of claim 12, wherein the first data segment is used for training an artificial intelligence model.

20. The non-transitory CRM of claim 12, wherein the second determination is based on the GPU having sufficient computing and memory resources available for the EC.
